(19) United States
(12) Patent Application Publication
(10) Pub. No.: US 2019/0027771 A1
(43) Pub. Date: Jan. 24, 2019

(54) ACID GAS REGENERABLE BATTERY

(71) Applicant: Commonwealth Scientific and Industrial Research Organisation, Acton, Australian Capital Territory (AU)

(72) Inventors: Paul Hubert Maria FERON, Cameron Park, New South Wales (AU); Robert BENNETT, Hamilton North, New South Wales (AU); Anthony Frank HOLLENKAMP, Camberwell, Victoria (AU); Kangkang LI, Mayfield West, NSW (AU)

(21) Appl. No.: 16/063,138

(22) PCT Filed: Dec. 19, 2016
(86) PCT No.: PCT/AU2016/051260

§ 371 Date: Jun. 15, 2018

(30) Foreign Application Priority Data
Dec. 17, 2015 (AU) 2015905242

(51) Int. Cl. H01M 8/22; H01M 8/18; B01D 53/14; B01D 53/40; B01D 53/62; B01D 53/78; B01D 53/96

(52) U.S. Cl. CPC H01M 8/222; B01D 2258/0283; B01D 53/1425; B01D 53/1475; B01D 53/1493; B01D 53/40; B01D 53/62; B01D 53/78; B01D 53/965; B01D 2252/102; B01D 2252/20494; B01D 2252/20421; B01D 2252/20405; B01D 2252/2041; B01D 2252/20473; B01D 2252/20447; B01D 2252/20442; B01D 2252/20426; B01D 2252/20484; B01D 2252/20489; B01D 2257/302; B01D 2257/304; B01D 2257/404; B01D 2257/504; B01D 2257/2047; B01D 2257/2045; B01D 2257/408; H01M 8/182

(57) ABSTRACT

A method of generating electricity from an amine-based acid gas capture process using an electrolytic cell containing an anode and a cathode and an amine based electrolyte comprising: contacting a metal based redox material with an amine based electrolyte in the presence of an anode to form a metal-ammine complex in solution; adding an absorbed or absorbable acid gas to the metal-ammine complex containing electrolyte to form an acid gas absorbed electrolyte; and contacting the acid gas absorbed electrolyte with a cathode deposit, wherein the acid gas breaks up the metal-ammine complex in the metal-ammine complex containing electrolyte thereby generating a potential difference between the anode and the cathode.

### PRIORITY CROSS-REFERENCE

The present application claims priority from Australian Provisional Patent Application No. 2015905242 filed 17 Dec. 2015, the contents of which are to be incorporated in this specification by this reference.

### TECHNICAL FIELD

The present invention generally relates to an acid gas regenerable electrolytic cell or battery. The invention is particularly applicable to amine-based CO₂-capture process and use thereof to generate electricity from an amine-based CO₂-capture process and it will be convenient to hereinafter disclose the invention in relation to that exemplary application. However, it is to be appreciated that the invention is not limited to that application and could be used in any application where an acid gas is utilised.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Thermally regenerative ammonia based batteries (TRAB's) are under development which are capable of converting low-grade thermal energy efficiently into electricity based on the cyclic formation and destruction of Cu-ammine complexes in aqueous solutions (see for example references 1 and 2). In such electrochemical energy conversion systems, ammonia is used as a complexation medium for Cu. As shown in the reactions below, Cu is dissolved from a Cu based anode to form an aqueous complex with ammonia. The Cu ion from this complex is subsequently released from the aqueous complex through heating which thereafter deposits on the cathode of the system.

The following reactions take place at the electrodes:

Anode

Cu(s)+4NH₃(aq)→[Cu(NH₃)₄]²⁺(aq)+2e⁻ (1)

Cathode

Cu²⁺(aq)+2e⁻→Cu(s) (2)

An appreciable amount of thermal energy is required to break up the Cu-ammine complex (Cu(NH₃)₄]²⁺) formed in reaction 1. The energy efficiency of such systems is therefore dependent on the thermal energy requirements of the overall system and the nature of the source of thermal energy used in the system.

It would therefore be desirable to provide a new and/or alternate electrochemical energy conversion system based on the cyclic formation and destruction of Cu-ammine complexes.

### SUMMARY OF THE INVENTION

A first aspect of the present invention provides a method of generating electricity from an amine-based acid gas capture process using an electrolytic cell containing an anode and a cathode and an amine based electrolyte comprising:

1. contacting a metal based redox material with an amine based electrolyte in the presence of an anode to form a metal-ammine complex in solution;
2. adding an absorbed or absorbable acid gas to the metal-ammine complex containing electrolyte to form an acid gas absorbed electrolyte; and
3. contacting the acid gas absorbed electrolyte with a cathode,

wherein the acid gas breaks up the metal-ammine complex in the metal-ammine complex containing electrolyte thereby generating a potential difference between the anode and the cathode.

The electrochemical cell of the present invention therefore provides a method of generating electricity from an amine-based acid gas capture process. The present invention utilises captured acid gases such as CO₂, NO₂, SO₂ and H₂S to break up the metal-ammine complex formed between the metal based redox material and amine based electrolyte for electricity generation within an electrochemical energy conversion systems utilising cyclic formation and destruction of that metal-ammine complex in aqueous solution. No other process known to the Inventors is able to generate electricity in this manner.

It should be appreciated that “break up” in the context of captured acid gases such as CO₂, NO₂, SO₂ and H₂S are used to break up the metal-ammine complex formed between the metal based redox material refers to those gases dissociating of otherwise splitting or separating the metal-ammine complex into smaller molecules or component molecules and the component metal ion. Examples of this dissociative reaction are provided in the detailed description, for example in reaction equation (4) and (6) in relation to CO₂.

It should be appreciated that the break up of the metal-ammine complex is possible through detection of deposition of the respective metal on the cathode as for example is set out in reactions (4) and (6) set out in the detailed description. The break-up of the metal-ammine complex can also be detected through a change in pH of the solution and/or spectroscopic methods based on UV/VIS.

The present invention also provides an option to further reduce the parasitic energy demand for an acid gas capture process. Amine-based capture processes (such as CO₂-capture processes) are known to require large amounts of (thermal) energy for regeneration of the amine solutions which have absorbed the CO₂. This process enables the recovery of part of this energy as electrochemical energy. In some embodiments, the energy generated can be close to or in some cases equivalent to the parasitic energy penalty due to capture. In such embodiments, this could result in a small to zero energy penalties for CO₂ capture.

The present invention can be used with a variety of acid gases. In embodiments, the acid gas comprises at least one of CO₂, NO₂, SO₂, H₂S, HCl, HF, or HCN or a combination thereof. The acid gas can result from a variety sources. In certain embodiments, the acid gas comprises a flue gas, for example a combustion flue gas. However, a variety of other flue gas sources are also possible. In many embodiments the acid gas comprises a combustion gas which includes CO₂ as a major component. In yet other embodiments, the acid gas comprises a pure acid gas, for example high purity CO₂.

The metal based redox material can take any suitable form which can undergo a valance change when contacted with the amine based electrolyte.

In some embodiments, the anode and cathode comprise the metal based redox material. In these embodiments, the metal based redox material is preferably deposited on that cathode when the absorbable acid gas breaks up the metal-ammine complex. A variety of metal based redox materials can be used to form complexes with the amine based electrolyte. In its broadest form, any transition metal could possibly be used in the present invention. However, the effectiveness of a transition metal in the present invention depends on (1) the ability of the metal to form a complex with selected amine based electrolytes; and (2) the ability of that complex to be disrupted or otherwise broken up by a selected acid gas. A suitable metal based redox material comprises a material which maximises acid gas absorption and forms a suitable complex with an amine based electrolyte.

In some embodiments (and as discussed in the background), copper (Cu) can be used. Apart from copper (Cu); Ni, Zn, Co, Pt, Ag, Cr, Pb, Cd, Hg, Pd or the like may be suitable for the metal based redox material depending on the electrode potential and the ability for amines to form complexes with these metals. Accordingly, the metal based redox material preferably comprises at least one of Cu, Ni, Zn, Co, Pt, Ag, Cr, Pb, Cd, Hg, Pd or a combination thereof. In some embodiments, the metal comprises Cu, Ni, Zn, Co, Pt, Ag, Cr, Pb. In some embodiments, the metal comprises Cu, Ni, Zn, Co, Pt, Ag, Cd, Hg, Pd. In preferred embodiments, the metal comprises Cu, Ni or Zn, and more preferably Cu. It should be appreciated that the metal based redox material could comprise a single material, for example a single metal or ion thereof, or could comprise a mixture or combination of two or more materials, for example two or more of the above metals or ions thereof.

In other embodiments, the metal based redox material comprises a multivalent metal ion which is in a first valence state when in solution and a second valence state when in the metal-ammine complex. In these embodiments, the formation and breakup of the metal-ammine complex changes the valancy of the metal based redox material. The anode and cathode in the electrolytic cell can have any suitable form. Preferably, the anode and cathode comprise inert anodes, for example formed from platinum, gold, copper or other suitable metal or material.

A variety of amine based electrolyte can be used having the capability to form complexes with metal ions of the metal based redox material. In embodiments, the amine based electrolyte comprises the general formula R₁ R₂ R₃N, wherein R₁, R₂ and R₃ comprise hydrogen, unsubstituted or substituted C1-C20 alkyl, or unsubstituted or substituted aryl.

As used herein, an alkyl group can be a substituted or unsubstituted, linear or branched chain saturated radical, it is often a substituted or an unsubstituted linear chain saturated radical, more often an unsubstituted linear chain saturated radical. A C1-C20 alkyl group is an unsubstituted or substituted, straight or branched chain saturated hydrocarbon radical. Typically it is C1-C10 alkyl, for example methyl, ethyl, propyl, butyl, pentyl, hexyl, heptyl, octyl, nonyl or decyl, or C1-C6 alkyl, for example methyl, ethyl, propyl, butyl, pentyl or hexyl, or C1-C4 alkyl, for example methyl, ethyl, i-propyl, n-propyl, t-butyl, s-butyl or n-butyl.

When an alkyl group is substituted it typically bears one or more substituents selected from substituted or unsubstituted C1-C20 alkyl, substituted or unsubstituted aryl (as defined herein), cyano, amino, C1-C10 alkylamino, di(C1-C10)alkylamino, arylamino, diarylamino, arylalkylamino, amido, acylamido, hydroxy, oxo, halo, carboxy, alcohol (i.e. —OH), ester, acyl, acyloxy, C1-C20 alkoxy, aryloxy, haloalkyl, sulfonic acid, sulfhydryl (i.e. thiol, —SH), d-C10 alkylthio, arylthio, sulfonyl, phosphoric acid, phosphate ester, phosphonic acid and phosphonate ester. Examples of substituted alkyl groups include haloalkyl, hydroxyalkyl, aminoalkyl, alkoxyalkyl and alkaryl groups. The term alkaryl, as used herein, pertains to a C1-C20 alkyl group in which at least one hydrogen atom has been replaced with an aryl group. Examples of such groups include, but are not limited to, benzyl (phenylmethyl, PhCH₂—), benzhydryl (Ph₂CH—), trityl (triphenylmethyl, Ph₃C—), phenethyl (phenylethyl, Ph-CH₂CH₂—), styryl (Ph-CH═CH—), cinnamyl (Ph-CH═CH—CH₂—). Typically a substituted alkyl group carries 1, 2 or 3 substituents, for instance 1 or 2.

An aryl group is a substituted or unsubstituted, monocyclic or bicyclic aromatic group which typically contains from 6 to 14 carbon atoms, preferably from 6 to 10 carbon atoms in the ring portion. Examples include phenyl, naphthyl, indenyl and indanyl groups. An aryl group is unsubstituted or substituted. When an aryl group as defined above is substituted it typically bears one or more substituents selected from C1-C6 alkyl which is unsubstituted (to form an aralkyl group), aryl which is unsubstituted, cyano, amino, C1-C10 alkylamino, di(C1-C10)alkylamino, arylamino, diarylamino, arylalkylamino, amido, acylamido, hydroxy, halo, carboxy, alcohol (i.e. —OH), ester, acyl, acyloxy, C1-C20 alkoxy, aryloxy, haloalkyl, sulfhydryl (i.e. thiol, —SH), C1-10 alkylthio, arylthio, sulfonic acid, phosphoric acid, phosphate ester, phosphonic acid and phosphonate ester and sulfonyl. Typically it carries 0, 1, 2 or 3 substituents. A substituted aryl group may be substituted in two positions with a single C1-C6 alkylene group, or with a bidentate group represented by the formula —X—(C1-C6)alkylene, or —X—(C1-C6)alkylene-X—, wherein X is selected from O, S and R, and wherein R is H, aryl or C1-C6 alkyl. Thus a substituted aryl group may be an aryl group fused with a cycloalkyl group or with a heterocyclyl group. The ring atoms of an aryl group may include one or more heteroatoms (as in a heteroaryl group). Such an aryl group (a heteroaryl group) is a substituted or unsubstituted mono- or bicyclic heteroaromatic group which typically contains from 6 to 10 atoms in the ring portion including one or more heteroatoms. It is generally a 5- or 6-membered ring, containing at least one heteroatom selected from O, S, N, P, Se and Si. It may contain, for example, 1, 2 or 3 heteroatoms. Examples of heteroaryl groups include pyridyl, pyrazinyl, pyrimidinyl, pyridazinyl, furanyl, thienyl, pyrazolidinyl, pyrrolyl, oxazolyl, oxadiazolyl, isoxazolyl, thiadiazolyl, thiazolyl, isothiazolyl, imidazolyl, pyrazolyl, quinolyl and isoquinolyl. A heteroaryl group may be unsubstituted or substituted, for instance, as specified above for aryl. Typically it carries 0, 1, 2 or 3 substituents.

The amine base electrolyte can therefore comprise ammonia or any suitable amine including primary, secondary of tertiary amines. In some embodiments, R₁ in the organic cation is hydrogen, methyl or ethyl, R₂ is hydrogen, methyl or ethyl and R₃ is hydrogen, methyl or ethyl. For instance R₁ may be hydrogen or methyl, R₂ may be hydrogen or methyl, R₂ is hydrogen or methyl. In some embodiments, R₁, R₂ and R₃ are hydrogen. Examples include: NH₃, R₁NH₂, and R₁R₂NH. In other embodiments, the amine base electrolyte can comprise a tertiary amine. In some embodiments, the amine based electrolyte comprises at least one of ammonia, alkylamines, alkanolamines, amino-acid salts or combination thereof. In preferred embodiments, the amine based electrolyte comprises an aqueous ammonia solution. It should be appreciated that in some embodiments at least one of R1, R2 or R3 can include alcohol groups.

In embodiments, the amine base electrolyte comprises at least one alkanolamine, alkylamine or amino-acid salt compound. In some embodiments, the amine base electrolyte comprises an amino acid salt selected from the group consisting of L-arginine, taurine, L-threonine, L-serine, glutamic acid, glycine, L-alanine, sarcosine, and L-proline. In some embodiments, the amine base electrolyte comprises an alkylamine selected from the group consisting of ammonia, propylamine, butylamine, amylamine, ethylenediamine, 1,3 diaminopropane, hexamethylenediamine, m-Xylylenediamine, 1-(3-aminopropyl)imidazole, piperazine, 4-methylpiperidine, pyrrolidine, 3-(dimethylamino)-1-propylamine, and n-methyl-1,3-diaminopropane. In some embodiments, the amine base electrolyte comprises an alkanolamine selected from the group consisting of triethanolamine, 2-amino-2-methyl-1 3-propanediol, diethanolamine, bis(2-hydroxypropyl)amine, 2-(2-aminoethoxy)ethanol, ethanolamine, 3-amino-1-propanol and 5-amino-1-pentanol.

Furthermore, the amine based electrolyte could include or comprise ionic liquids with amine functionality or consist of mixtures or ionic liquids with amines or amino-acid salts. Ionic liquids with amine functionality can be used to react with metals and CO₂ and have good solubility for metal ions. The use of ionic liquids can be beneficial in circumventing some issues associated with low solubility of certain metal based redox materials in aqueous solutions.

The amine based electrolyte can have an amine content of any suitable concentration. It is preferred that this concentration is as high as possible, but should be understood to be limited by the solubility limitation of the metal based redox material within that amine based electrolyte. The concentration of the amine based electrolyte can vary from 0.1 to 10 molar amine solutions. In some embodiments, the amine based electrolyte will comprise 1 to 10 molar amine solutions. For example, the amine based electrolyte may comprise 3 to 5 molar amine solutions. For post-combustion capture applications higher concentrations could be used, for example from 5 to 10 molar amine solutions. For CO₂-capture from air, the concentration of CO₂ is much smaller and therefore may have 0.1 M in air applications.

It should be appreciated that the given stoichiometries determine the boundaries of the acid gas-amine chemistry used in the present invention. Depending on the stoichiometry, the ratio of the absorbed or absorbable acid gas to the metal-ammine complex containing electrolyte (“amine—acid gas ratio”) is preferably between 1:1 and 2:1. For example, for CO₂ in the case of carbamate formation (non-sterically hindered, primary and secondary amines) the amine-gas ratio is 2 to 1; in the case of bicarbonate formation (sterically hindered primary amines and tertiary amines) the amine acid gas ratio is 1 to 1. This ratio is also applicable to all other acid gases. It should also be appreciated that comparable acid gas reactions between CO₂ and ammonia are actually different. Such a reaction produces both carbamate and bicarbonate in a temperature dependent equilibrium.

The metal-amine chemistry in the presence of acid gas typically depends on the type of metal based redox material and amine based electrolyte forming the metal-ammine complex in solution. For ammonia the number of ammonia molecules coordinated with the metal can vary from 1 to 6 (for Ni). For suitable concentration ranges of metal-ammine complex in solution, the limiting factors include solubility of the free metal ion in the relevant solution (hydroxide, bicarbonate or carbonate) will determine the maximum workable concentrations for the cases where the metal will be free in solution. Whilst not considered limiting to the invention, the concentration of metal-ammine complex in solution can in embodiments vary from 0.01 to 5M, preferably from 0.5 to 2M. In references 1 and 2 Cu²⁺ concentrations of 0.05 and 0.1 M are used with excess ammonia (2M) in a 5M NH₄NO₃ aqueous electrolyte for a system without CO₂. These authors do not mention issues with the precipitation of metal salts. The data in reference 3 illustrates that in the presence of CO₂Cu²⁺ has a solubility in a 3M ammonia solution of at least 0.6 M in the CO₂-loading range relevant to a capture process. This example illustrates the system can be operated in a practical concentration range.

A variety of combinations of metal based redox materials and amine based electrolytes can be used in the present invention. In exemplary embodiments, the metal based redox material comprises Cu and the amine based electrolyte comprises ammonia and the metal-ammine complex comprises [Cu(NH₃)₄]²±.

The acid gas can be added to the metal-ammine complex containing electrolyte indirectly or directly.

In some embodiments, the acid gas can be added to the metal-ammine complex containing electrolyte indirectly in solution form. In these embodiments, a capture solution, for example the metal-ammine complex containing electrolyte is used to capture the acid gas in a gas liquid contacting vessel or process (for example a packed bed absorber, bubble column, falling film absorber, pressure swing absorber, spray absorber or the like) to produce an acid gas rich solution. That acid gas rich solution is then added to the the metal-ammine complex containing electrolyte. For example, the metal-ammine complex containing electrolyte can be used as the acid gas absorbent in a gas-liquid contactor. In these embodiments, a gas-liquid contactor can be used to form the solution of acid gas to the metal-ammine complex containing electrolyte. One suitable gas-liquid contactor is described in U.S. Pat. No. 9,073,006 the contents of which should be understood to be incorporated into this specification by this reference. It should be appreciated that a variety of other gas-liquid contactor types and configurations could also be used.

In other embodiments, the acid gas is added directly to the metal-ammine complex containing electrolyte. In these embodiments, the acid gas is directly absorbed in the amine complex containing electrolyte in the electrolytic cell without the use of a separate absorption vessel. In some embodiments, a small amount of acid gas can be absorbed and desorbed from the amine based electrolyte to cyclically break up the metal-ammine complex. This smaller amount of acid gas (for example high purity CO₂) can use a compact gas-liquid absorption system (sparger, bubble, falling film etc) to achieve the requisite absorption of acid gas within the electrolyte.

The acid gas absorbed electrolyte can be thermally regenerated to enable reuse in the process. In some embodiments, the method further includes the step of:

contacting the acid gas absorbed electrolyte with a cathode, heating the acid gas absorbed electrolyte to release the absorbed acid gas therefrom and thermally regenerate the amine based electrolyte.

For example, where the acid gas comprises CO₂ and the amine based electrolyte comprises ammonia, the regeneration reaction comprises the recovering ammonia and CO₂ from the carbamate and ammonium ion. The recovered ammonia is preferably reused in the anode compartment. In this regard, the regenerated amine based electrolyte is preferably recycled for use in the step of contacting the metal based redox material with the amine based electrolyte. Any suitable gas desorption process can be used, such as a stripper, flash unit or the like.

The acid gas absorbed electrolyte can be heated using any suitable heat source. Suitable heat sources include resistive heating, thermal heating, solar heating, solar-thermal heating, geothermal heating, steam heating, waste heat, low grade heat sources, radiative heat sources or the like. In some embodiments, the heat source can be from a co-located process or plant. For example, if used in a power station, heat sources from that power station could be used for this purpose. Similarly, the heating source can include any suitable heating component including heat exchangers, resistance heating sources, such as heating coils, induction heater, convective heaters, radiation heaters, solar heating or the like.

It should be appreciated that heating of the electrolyte is aimed at creating a pH swing within the acid gas absorbed electrolyte. Accordingly, other pH swing techniques could also be employed to desorb the acid gas. In some embodiments, optically induced negative changes of pH can be utilised, such as can be seen in spiropyran and naphthol type photoacids or optically induced positive pH changes as seen in carbinol bases of triarylmethanes. For these molecular systems, reversible pH changes can be achieved by irradiation with a suitable wavelength followed by a return to the initial pH upon removal of irradiation. In other embodiments, pH changes may also be driven electrochemically with use of ion selective membranes or functionalised nanoparticles. In some embodiments, the application of potential may be used to reversibly release protons into solution or vice versa.

The electrolytic cell can have any suitable configuration. In some embodiments the electrolytic cell includes an anode chamber and a cathode chamber, and the metal based redox material is contacted with an amine based electrolyte in the anode chamber.

Steps 2 and 3 of the process of the first aspect of the present invention (i.e. adding a solution of absorbed or absorbable acid gas to the metal-ammine complex containing electrolyte to form an acid gas absorbed electrolyte; and contacting the cathode metal with the acid gas absorbed electrolyte to deposit the metal based redox material thereon) are preferably integrated in the cathode chamber when the absorption of CO₂ occurs in the cathode chamber. Accordingly, the solution of absorbed or absorbable acid gas is added to the metal-ammine complex containing electrolyte in the cathode chamber.

In use, the amine based electrolyte is preferably only used as an anolyte (electrolyte surrounding an anode) that reacts with the copper electrode as waste heat warms the electrolyte, generating electricity. When the reaction uses up the amine component of the electrolyte or depletes the metal ions in the electrolyte near the cathode the reaction stops. The addition of the acid gas then is used to distil the amine component of the electrolyte from the used anolyte. The regenerated electrolyte is then added to the cathode chamber. The electrochemical cell's polarity is then reverses and the anode becomes the cathode and vice versa. Thus in embodiments, in use, the electrolytic cell comprises a first electrode compartment and second electrode compartment that are cyclically interchanged as the anode compartment and the cathode compartment of the electrolytic cell.

The potential difference generated between the anode and the cathode may be dependent on the configuration, size and composition of the electrolytic cell. In embodiments, this potential difference is between 0.05V to 1.5V and more preferably at least at least 0.1V, even more preferably at least 0.2V and yet even more preferably at least 0.3V.

The present invention also provides an acid gas regenerable electrolytic cell. For embodiments where the anode and cathode comprise the metal based redox material, the electrolytic cell can be defined in accordance with the following second aspect of the present invention.

A second aspect of the present invention provides an acid gas regenerable electrolytic cell comprising:

a first electrode compartment containing an electrode comprising at least one metal based redox material and a first electrolyte comprising an amine based electrolyte;

a second electrode compartment containing an electrode comprising at least one metal based redox material and a second electrolyte comprising an amine based electrolyte; and

a gas-liquid contactor located to operatively contact at least one of the first electrolyte or second electrolyte to facilitate acid gas absorption within the respective electrolyte,

wherein, in use, the first electrode compartment and second electrode compartment are selectively interchanged as an anode compartment and an cathode compartment of the electrolytic cell.

The electrolytic cell of the second aspect of the present invention is therefore operated with the electrode compartments functioning as transposable anode and cathodes (reversible polarity). In use, the first electrode compartment and second electrode compartment are selectively interchanged, preferably periodically interchanged as an anode compartment and a cathode compartment of the battery. The gas-liquid contactor is fed into the electrolyte in the respective cathode compartment a solution of absorbed or absorbable acid gas to form an acid gas absorbed electrolyte. The electrolyte in the respective cathode compartment is then used for metal deposition, for example as shown in reaction 2.

It should be appreciated that this second aspect of the present invention can include a number of the features described above in relation to the first aspect of the present invention, and that the disclosure above in relation to this first aspect of the present invention equally applies to similar or equivalent aspects of this second aspect of the present invention.

Again the electrolytic cell can have any suitable configuration. In some embodiments, the first electrode compartment and second electrode compartment comprise fluid tight receptacles housing the respective electrode. In embodiments, the first electrode compartment and second electrode compartments are fluidly separated by an anion exchange membrane. The electrolytic cell of the present invention preferably comprises a battery.

Like the first aspect of the present invention at least the first or second electrolyte preferably comprises an amine based electrolyte having the general formula R₁R₂R₃N, wherein R₁ R₂ and R₃ comprise hydrogen, unsubstituted or substituted C1-C20 alkyl, or unsubstituted or substituted aryl. In embodiments, the amine base electrolyte comprises at least one alkanolamine, alkylamine or amino-acid salt compound as discussed above in relation to the first aspect of the present invention. Similarly, the metal based redox material preferably comprises at least one of Cu, Ni, Zn, Co, Pt, Ag, Cr, Pb, Cd, Hg, Pd or a combination thereof again as discussed in relation to the first aspect of the present invention. Moreover, the acid gas preferably comprises at least one of CO₂, NO₂, SO₂, H₂S, HCl, HF, or HCN or a combination thereof. It should be understood that the above described features of these components of the first aspect of the present invention equally apply the equivalent components of this second aspect of the present invention.

The gas-liquid contactor of the present invention can have any suitable configuration. In some embodiments, the gas-liquid contactor includes at least one of sparger, a venturi tube, a bubble inlet, a packed column, a bubble column, a spray tower, a falling film column, a plate column, a rotating disc contactor, an agitated vessel or a gas-liquid membrane contactor.

In some embodiments, the acid gas flow comprises a large volume of gas, for example flue gas. In these embodiments, the acid gas has high volume but low concentrations of acid gas. The acid gas is preferably captured in a separate gas-liquid contactor and then added to the metal-ammine complex containing electrolyte indirectly in solution form. In these embodiments, the gas-liquid contactor comprises a gas liquid contacting vessel or process such as a packed bed absorber, bubble column, falling film absorber or the like) to produce an acid gas rich solution. That acid gas rich solution is then added to the the metal-ammine complex containing electrolyte. As noted previously, one suitable gas-liquid contactor is described in U.S. Pat. No. 9,073,006.

In other embodiments, the acid gas can comprise a lower volume more concentrated acid gas flow, for example high purity carbon dioxide. In these embodiments, it may be possible to add or absorb the acid gas is directly into the metal-ammine complex containing electrolyte within the electrolytic cell. In these embodiments, the acid gas absorbed directly in the amine complex containing electrolyte in the electrolytic cell without the use of a separate absorption vessel. Suitable gas-liquid contactors include spargers and other bubble injectors, gas-liquid membrane contactors or the like. In some forms, the acid gas can be absorbed and desorbed from the amine based electrolyte to cyclically break up the metal-ammine complex. This smaller amount of acid gas (for example high purity CO₂) can use a compact gas-liquid absorption system (bubble, falling film etc) to achieve the requisite absorption of acid gas within the electrolyte.

Again, in use the electrochemical cell's polarity is interchanged or reversed periodically such that the anode becomes the cathode and vice versa. In embodiments, the first electrode compartment and second electrode compartment are cyclically interchanged as an anode compartment and an cathode compartment of the battery when at least one of:

a specified amount of metal based redox material is removed from the electrode;

the potential difference/voltage between the anode and cathode falls below a specified level/voltage;

a specified amount of amine based electrolyte is reacted; or

the metal based redox material has contacted the amine based electrolyte is reacted for a specified amount of time.

Some embodiments can further include a regenerative heating source for heating the acid gas absorbed electrolyte to release the absorbed acid gas therefrom and thermally regenerate the amine based electrolyte. Suitable heat sources include resistive heating, thermal heating, solar heating, solar-thermal heating, geothermal heating, steam heating, waste heat, low grade heat sources, radiative heat sources or the like. In some embodiments, the heat source can be from a co-located process or plant. The regenerative heating source can comprise any suitable thermal energy source including heat exchangers, resistance heating sources, such as heating coils, induction heater, convective heaters, radiation heaters, solar heaters or the like. Any suitable gas desorption process can be used, such as a stripper, flash unit or the like. Where a stripper column is used the stripper column preferably includes a reboiler for heating the electrolyte and a condenser for condensing electrolyte vapour near an acid gas exit of the stripper.

A third aspect of the present invention provides use of a regenerable electrolytic cell comprising: a first electrode compartment containing an electrode, least one metal based redox material and a first electrolyte comprising an amine based electrolyte; a second electrode compartment containing an electrode, at least one metal based redox material and a second electrolyte comprising an amine based electrolyte, wherein, a gas-liquid contactor operatively contacts at least one of the first electrolyte or second electrolyte is used to facilitate acid gas absorption within the electrolyte.

As described in relation to the first aspect of the present invention, the metal based redox material can take any suitable form which can undergo a valance change when contacted with the amine based electrolyte.

In some embodiments, the anode and cathode comprise the metal based redox material. In these embodiments, the metal based redox material is preferably deposited on the cathode when the absorbable acid gas is absorbed into the first electrolyte or second electrolyte.

It should be appreciated that this third aspect of the present invention can include a number of aspects described in relation to the first and second aspects of the present invention. For example, the first and second electrolytes of this aspect of the present invention could comprise the amine based electrolytes taught in relation to the first and second aspect of the present invention. Similarly, the metal based redox material can comprise the materials taught in relation to the first and second aspect of the present invention.

In some embodiments, in use, the first electrode compartment and second electrode compartment are cyclically interchanged as an anode compartment and a cathode compartment of the electrolytic cell.

Again the electrolytic cell can have any suitable configuration. In some embodiments, the first electrode compartment and second electrode compartment comprise fluid tight receptacles housing the respective electrode. In embodiments, the first electrode compartment and second electrode compartments are fluidly separated by an anion exchange membrane. The electrolytic cell of the present invention preferably comprises a battery.

Like the first aspect of the present invention at least the first or second electrolyte preferably comprises an amine based electrolyte having the general formula R₁R₂R₃N, wherein R₁ R₂ and R₃ comprise hydrogen, unsubstituted or substituted C1-C20 alkyl, or unsubstituted or substituted aryl. In embodiments, the amine base electrolyte comprises at least one alkanolamine, alkylamine or amino-acid salt compound as discussed above in relation to the first aspect of the present invention. Similarly, the metal based redox material preferably comprises at least one of Cu, Ni, Zn, Co, Pt, Ag, Cr, Pb, Cd, Hg, Pd or a combination thereof again as discussed in relation to the first aspect of the present invention. Moreover, the acid gas preferably comprises at least one of CO₂, NO₂, SO₂, H₂S, HCl, HF, or HCN or a combination thereof. It should be understood that the above described features of these components of the first aspect of the present invention equally apply the equivalent components of this second aspect of the present invention.

The gas-liquid contactor of the present invention can have any suitable configuration. In some embodiments, the gas-liquid contactor includes at least one of sparger, a venturi tube, a bubble inlet, a packed column, a bubble column, a spray tower, a falling film column, a plate column, a rotating disc contactor, an agitated vessel or a gas-liquid membrane contactor.

In some embodiments, the acid gas flow comprises a large volume of gas, for example flue gas. In these embodiments, the acid gas has high volume but low concentrations of acid gas. The acid gas is preferably captured in a separate gas-liquid contactor and then added to the metal-ammine complex containing electrolyte indirectly in solution form. In these embodiments, the gas-liquid contactor comprises a gas liquid contacting vessel or process such as a packed bed absorber, bubble column, falling film absorber or the like) to produce an acid gas rich solution. That acid gas rich solution is then added to the the metal-ammine complex containing electrolyte. As noted previously, one suitable gas-liquid contactor is described in U.S. Pat. No. 9,073,006.

In other embodiments, the acid gas can comprise a lower volume more concentrated acid gas flow, for example high purity carbon dioxide. In these embodiments, it may be possible to add or absorb the acid gas is directly into the metal-ammine complex containing electrolyte within the electrolytic cell. In these embodiments, the acid gas absorbed directly in the amine complex containing electrolyte in the electrolytic cell without the use of a separate absorption vessel. Suitable gas-liquid contactors include spargers and other bubble injectors, gas-liquid membrane contactors or the like. In some forms, the acid gas can be absorbed and desorbed from the amine based electrolyte to cyclically break up the metal-ammine complex. This smaller amount of acid gas (for example high purity CO₂) can use a compact gas-liquid absorption system (bubble, falling film etc) to achieve the requisite absorption of acid gas within the electrolyte.

Again, in use the electrochemical cell's polarity is interchanged or reversed periodically such that the anode becomes the cathode and vice versa. In embodiments, the first electrode compartment and second electrode compartment are cyclically interchanged as an anode compartment and an cathode compartment of the battery when at least one of:

a specified amount of metal based redox material is removed from the electrode;

the potential difference/voltage between the anode and cathode falls below a specified level/voltage;

a specified amount of amine based electrolyte is reacted; or

the metal based redox material has contacted the amine based electrolyte is reacted for a specified amount of time.

Some embodiments can further include a regenerative heating source for heating the acid gas absorbed electrolyte to release the absorbed acid gas therefrom and thermally regenerate the amine based electrolyte. Suitable heat sources include resistive heating, thermal heating, solar heating, solar-thermal heating, geothermal heating, steam heating, waste heat, low grade heat sources, radiative heat sources or the like. In some embodiments, the heat source can be from a co-located process or plant. The regenerative heating source can comprise any suitable thermal energy source including heat exchangers, resistance heating sources, such as heating coils, induction heater, convective heaters, radiation heaters, solar heaters or the like. Any suitable gas desorption process can be used, such as a stripper, flash unit or the like. Where a stripper column is used the stripper column preferably includes a reboiler for heating the electrolyte and a condenser for condensing electrolyte vapour near an acid gas exit of the stripper.

A fourth aspect of the present invention provides a method of generating electricity from an amine-based acid gas capture process using a electrolytic cell containing a metal based redox material forming the anode and the cathode and an amine based electrolyte comprising:

1. contacting the anode metal with an amine based electrolyte to form a metal-ammine complex in solution;
2. adding a solution of absorbed or absorbable acid gas to the metal-ammine complex containing electrolyte to form an acid gas absorbed electrolyte; and
3. contacting the cathode metal with the acid gas absorbed electrolyte to deposit the metal based redox material thereon,

thereby generating a potential difference between the anode and cathode.

The electrochemical cell of this fourth aspect of the present invention therefore provides a method of generating electricity from an amine-based acid gas capture process. The present invention utilises captured acid gases such as CO₂, NO₂, SO₂ and H₂S to break up the metal-ammine complex formed between the anode metal and amine based electrolyte for electricity generation within an electrochemical energy conversion systems utilising cyclic formation and destruction of that metal-ammine complex in aqueous solution.

It should be appreciated that this fourth aspect of the present invention can include a number of aspects described in relation to the first and second aspects of the present invention.

A fifth aspect of the present invention provides use of a regenerable electrolytic cell according to the third aspect of the present invention, to generate electricity from an amine-based acid gas capture process using the method of the first aspect of the present invention.

A sixth aspect of the present invention provides method of generating electricity from an amine-based acid gas capture process according to the first aspect of the present invention using an electrolytic cell according to the second aspect of the present invention.

The present invention can find application in at least the following fields:
CO₂, SO₂, NO₂ capture from flue gas or exhaust gas using amines;
Acid (CO₂, H₂S) gas removal from natural gas, coal seam gas, tight gas, shale gas and biogas;
Pure acid gas such as CO₂ (i.e. an acid gas not mixed with other gases) in a completely enclosed system with recycle of the acid gas; and
CO₂ capture from air with power generation.

In all cases containing a gas mixture with acid gas components the gas separation process, which normally requires large amounts of energy, now generates energy through electro-chemical conversion.

### BRIEF DESCRIPTION OF THE DRAWINGS

The present invention will now be described with reference to the figures of the accompanying drawings, which illustrate particular preferred embodiments of the present invention, wherein:

FIG. 1 provides a general schematic of one embodiment an acid gas regenerable electrolytic cell incorporated into an acid gas capture process.

FIG. 2 provides a more detailed schematic of one embodiment of a regenerative electrolytic cell integrated post-combustion CO₂ capture process according to the present invention.

FIG. 3 provides a perspective view of an experimental an acid gas regenerable electrolytic cell according to one embodiment of the present invention.

FIG. 4 provides an open circuit potential vs time plot for the experimental acid gas regenerable electrolytic cell shown in FIG. 3 discharging against a 1.2 ohm resistor.

FIG. 5 provides absorption spectra of the spent and regenerated solution using the experimental acid gas regenerable electrolytic cell shown in FIG. 3.

### DETAILED DESCRIPTION

The present invention provides a method of generating electricity and an associated regenerable battery in which an amine-based acid gas-capture process can be utilised to generate electricity.

Capturing acid gases—such as the greenhouse gas carbon dioxide (CO₂) from coal-fired power station flue gas—is extremely important in mitigating global warming and climate change. Post-combustion carbon capture technology using chemical absorbents is often considered as the most cost effective and feasible option for large-scale removal of CO₂ from flue gases emitted from power plants and other industry facilities. One chemical absorbent of interest is aqueous ammonia-based CO₂ capture technology due to its high CO₂ absorption capacity, low regeneration energy, no sorbent degradation, cheap chemical cost, and simultaneous capture of multiple pollutants (including CO₂, SOₓ, NOₓ, HCl and HF). Several pilot and demonstration plants have been constructed and operated to test the technical and economic feasibility of this technology by industry and research organisations such as Alstom, Powerspan, Commonwealth Scientific and Industrial Research Organisation (CSIRO), Korea Institute of Energy Research (KIER) and Research Institute of Industrial Science & Technology (RIST), implying promising industrial applications.

Amine-based capture processes, such as ammonia based CO₂-capture processes require large amounts of (thermal) energy for regeneration of the amine solutions which have absorbed the CO₂. The process economics must therefore account for a high parasitic energy penalty to regenerate the absorbent.

The present invention relates to the utilisation of captured acid gases such as CO₂, NO₂, SO₂ and H₂S to break up a metal-ammine complex formed between the anode metal and amine based electrolyte for electricity generation within an electrochemical energy conversion system utilising cyclic formation and destruction of that metal-ammine complex in aqueous solution. The concept is based on the formation and controllable break down of metal complexes in an aqueous solution using the captured acid gas.

Whilst not wishing to be limited to any one theory, the Inventors have found that a metal-ammine complex such as the Cu-ammine complex aCu(NH₃)₄1^{2±}) formed in reaction 1 can also be broken up by the addition of acid gases introduced into the solution by gas-liquid contact, producing free NH₄⁺. Captured acid gases such as CO₂, NO₂, SO₂ and H₂S can therefore be used to break up the metal-ammine complex (for example [Cu(NH₃)₄]^{2±}) for electricity generation within an electrochemical energy conversion systems utilising cyclic formation and destruction of metal-ammine complexes in aqueous solutions.

The process of the present invention enables the recovery of part of the required thermal energy requirement as electrochemical energy. In some embodiments, the energy generated can be close to or in some cases equivalent to the parasitic energy penalty due to capture. In such embodiments, this could result in a small to zero energy penalties for CO₂ capture.

The overall reactions in the electrochemical cell for the present invention when used to capture carbon dioxide are as follows:

Anode

Me(s)+nR₁R₂R₃N(aq)→[Me(R₁R₂R₃N)ₙ]^{z+}(aq)+ze⁻ (3)

Addition of CO₂ directly from flue gas

mCO₂(aq)+[Me(R₁R₂R₃N)ₙ]^{z+}(aq)→nR₁R₂R₃N(CO₂)ₘ(aq)+Me^{z+}(aq) (4)

Cathode

Me^{z+}(aq)+ze⁻→Me(s) (5)

Reaction 4 and 5 might be integrated in the cathode compartment when the absorption of CO₂ occurs in the electrode compartment:

mCO₂(aq)+[Me(R₁R₂R₃N)ₙ]^{z+}(aq)+ze⁻→nR₁R₂R₃N(CO₂)ₘ(aq)+Me(s) (6)

Where R (i.e. R₁ R₂ R₃) typically represents groups taken from or a combination of —H, or —CH₂—, and/or —CH₃, or —CH₂OH, or —CH₂NH₂, or —SO₃⁻, or —COO⁻. More generally, in these reactions (and as discussed above) R₁, R₂ and R₃ can comprise hydrogen, unsubstituted or substituted C1-C20 alkyl, or unsubstituted or substituted aryl, and Me is a metal selected from at least one of Cu, Ni, Zn, Co, Pt, Ag, Cr, Pb or a combination thereof, and more preferably one of Cu, Ni or Zn. z corresponds to the valancy/cation charge of the respective metal Me. For primary/secondary monoamines, m=0.5; for primary/secondary diamines, m=1; for tertiary amine or sterically hindered amine or diamines, m=1. As defined previously, the unsubstituted or substituted C1-C20 alkyl, or unsubstituted or substituted aryl, can contain a variety of one or more substituents selected from C1-C6 alkyl which is unsubstituted (to form an aralkyl group), aryl which is unsubstituted, cyano, amino, C1-C10 alkylamino, di(C1-C10)alkylamino, arylamino, diarylamino, arylalkylamino, amido, acylamido, hydroxy, halo, carboxy, alcohol (i.e. —OH), ester, acyl, acyloxy, C1-C20 alkoxy, aryloxy, haloalkyl, sulfhydryl (i.e. thiol, —SH), C1-10 alkylthio, arylthio, sulfonic acid, phosphoric acid, phosphate ester, phosphonic acid and phosphonate ester and sulfonyl. It should be appreciated that in embodiments, at least one of R₁, R₂ and R₃ may include alcohol group substituents.

One specific example is where Cu-ammine complex can be used for CO₂-absorption and using the reaction products in an electro-chemical cell provides a pathway towards generation of electricity. Apart from ammonia other amines will have a similar propensity to form complexes with metal ions.

The following reactions will take place on the electrodes:

Anode

Cu(s)+4NH₃(aq)→[Cu(NH₃)₄]²⁺(aq)+2e⁻ (7)

Addition of CO₂ directly from flue gas

2CO₂(aq)+[Cu(NH₃)₄]²⁺(aq)→2NH₄⁺(aq)+2NH₂COO⁻(aq)+Cu²⁺(aq) (8)

Cathode

Cu²⁺(aq)+2e⁻→Cu(s) (9)

Reactions 8 and 9 might be integrated in the cathode compartment when the absorption of CO₂ occurs in the electrode compartment:

2CO₂(aq)+[Cu(NH₃)₄]²⁺(aq)+2e⁻→2NH₄+(aq)+2NH₂COO⁻(aq)+Cu(s) (10)

After deposition of Cu on the cathode, the aqueous mixture containing the carbamate and ammonium ion can be thermally regenerated in which CO₂ is released from the solution and the recovered ammonia is reused for Cu-dissolution in the anode compartment.

The overall reaction stoichiometry involves 2 mole of CO₂ per mole of Cu being dissolved or deposited.

It should be appreciated that the above reaction scheme could be equally applied to other acid gases, such as SO₂, H₂S, HCl, HF, HCN, in which case the carbamate formation does not take place and a simple acid-base reaction takes place. Reaction 11 gives the example for SO₂:

4SO₂(aq)+[Cu(NH₃)₄]²⁺(aq)+4H₂O(aq)→4NH₄⁺(aq)+4HSO₃⁻(aq)+Cu²⁺(aq) (11)

Reaction 11 and 9 might be integrated in the cathode compartment when the absorption of SO₂ occurs in the electrode compartment:

4SO₂(aq)+[Cu(NH₃)₄]²⁺(aq)+4H₂O(aq)+2e⁻→4NH₄⁺(aq)+4HSO₃⁻(aq)+Cu(s) (12)

The overall reaction stoichiometry involves 4 mole of SO₂ per mole of Cu being dissolved or deposited.

It should be appreciated that reactions 11 and 12 are also applicable to CO₂ interactions with tertiary amines or sterically hindered amines, i.e. where CO₂ reacts to form bicarbonate instead of carbamate.

A number of redox suitable metals can be used in the process and electrochemical cell of the present invention include Cu, Ni, Zn, Co, Pt, Ag, Cr, Pb or the like. The overall suitability of these metals depends on the electrode potential and the ability for amines to form complexes with these metals. The solubility of metals salts in aqueous solutions might pose a limit on the concentrations at which these metals can be used.

Advantageously, the use of metal ions can suppress volatilisation of selected amine based electrolytes in embodiments of the present invention. For example, ammonia has an intrinsically high volatility, which results in high ammonia loss during absorption and regeneration processes. The recovery of ammonia requires extra energy and facilities, adding costs to the CO₂ capture process. Moreover, vaporised ammonia can react with CO₂ in the gas phase in the presence of moisture and generate crystalline deposits which are predominantly comprised of ammonium bicarbonate capable of scale formation on associated surfaces of equipment. Reference 3 teaches that the addition of Me(II) ions (Ni, Cu and Zn) in ammonia based electrolytes significantly reduced ammonia loss in absorption and regeneration processes, and only slightly decreased the rate of CO₂ absorption. The order of ammonia suppression efficiency found was Ni(II)>Cu(II)>Zn(II). The regeneration result also showed that metal additives can accelerate the CO₂ desorption rate.

Apart from ammonia, other amines such as alkylamines, alkanolamines, amino-acid salts have the capability to form complexes with metal ions. For CO₂, the reaction for primary amines and secondary amines which form carbamates when in contact with CO₂ would be identical to the ones described for ammonia shown above (reactions 7 to 12).

The acid gas absorbed electrolyte can be thermally regenerated to enable reuse in the process. Here, the acid gas absorbed electrolyte is heated to release the absorbed acid gas therefrom and leaving a substantially acid gas free amine based electrolyte. For example, where the acid gas comprises CO₂ and the amine based electrolyte comprises ammonia, the regeneration reaction comprises the recovering ammonia and CO₂ from the carbamate and ammonium ion:

2NH₄⁺+2NH₂COO⁻+heat→4NH₃+2CO₂ (13)

The regenerated amine based electrolyte (e.g. recovered ammonia) is recycled for use in the step of contacting the anode metal with the amine based electrolyte in the anode compartment or chamber of the electrolytic cell.

The above reactions can be utilised to harvest the enthalpy released by the reaction of the acid gas with the amine based electrolyte. In current acid gas (for example CO₂) treatment processes this enthalpy is simply cooled away as the temperature levels are too low to be of practical use. Given that electrochemical energy conversion is not limited by the Carnot efficiency, the conversion efficiency can be quite high and be similar to flow batteries (˜0.75).

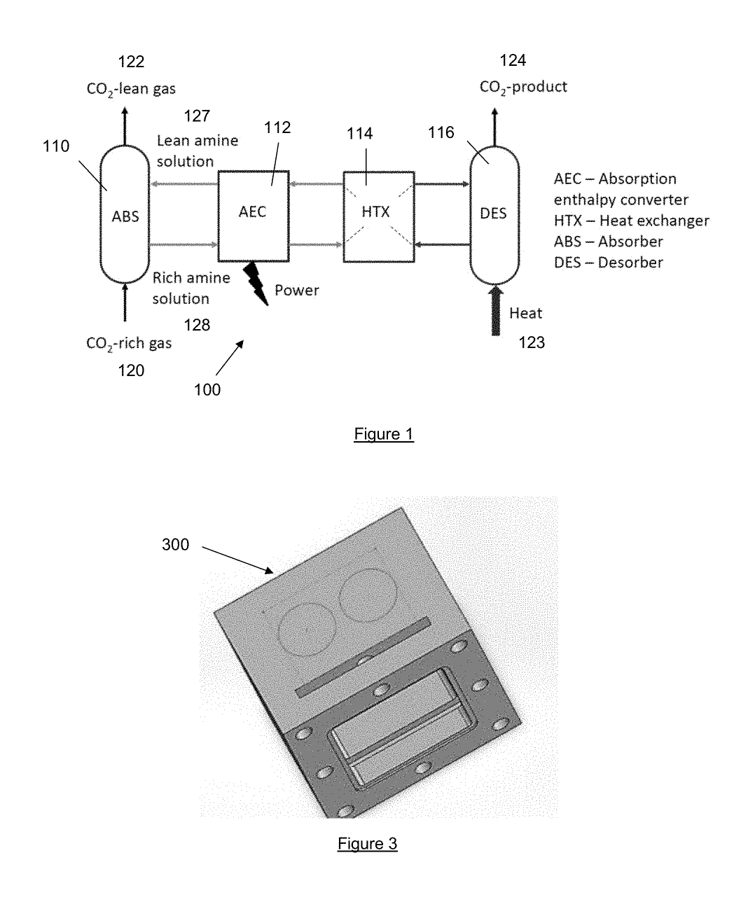

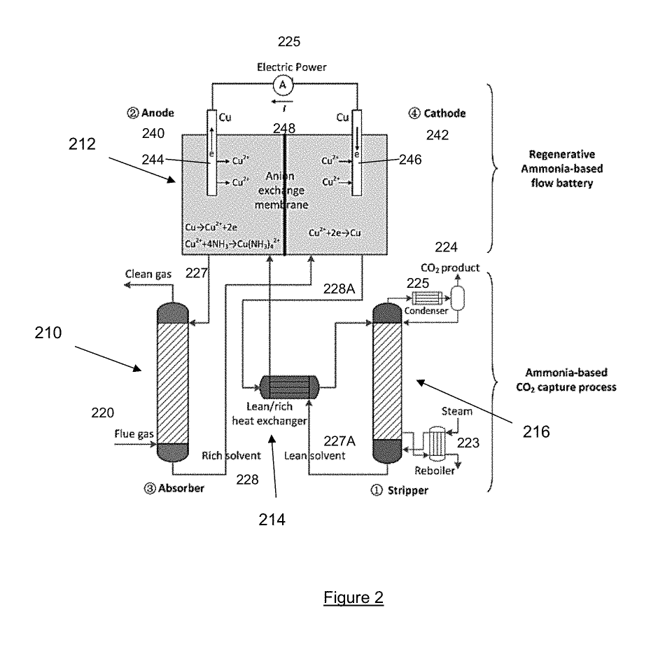

FIG. 1 shows an acid gas capture absorption enthalpy conversion process 100 according to one embodiment of the present invention. This process 100 includes the following fluidly linked process units:
Absorber 110, a gas-liquid contactor in which an acid gas rich feed 120 is fed into and contacted with a lean amine solution 127, typically the amine based electrolyte to absorb the acid gas, to produce a rich amine solution 128 comprising the acid gas absorbed electrolyte. An acid gas lean stream 122 is emitted from the absorber 110;
Absorption enthalpy converter 110 (typically in the form of a regenerable flow battery 210—see FIG. 2 and description below for more details) comprises an electrolytic cell in which the above described reactions are undertaken to generate power. Electrolyte stream 126 and 127 flow out from (stream 126) and into (stream 127) the absorption enthalpy converter 110.
Heat exchanger 114 used to exchange or transfer heat from electrolyte input stream 127 (higher temperature stream which flows from the desorber 116 where the electrolyte is heated) to electrolyte output stream 126 (lower temperature stream which flows from the absorption enthalpy converter 110); and
Desorber 116, preferably a stripping unit which is used to strip the acid gas from the electrolyte. As shown in FIG. 2, this typically uses a reboiler heated from a suitable heat source 123 (thermal, solar, waste heat, geothermal or the like) to strip the acid gas from the electrolyte. The acid gas product stream 124 exits the desorber 116, whilst the electrolyte is recycled back into the absorption enthalpy converter 110.

The schematic details of one form of absorption enthalpy converter 110 are shown in FIG. 2. It should be appreciated that components in FIG. 2 which correspond to components illustrated in FIG. 1 have been given the same reference numeral PLUS 100.

The process described above in relation to FIG. 1 can be implemented using an acid gas regenerable electrolytic cell 210 as shown in FIG. 2. The illustrated electrolytic cell 210 is constructed with at least a pair of electrode compartments, being an anode electrode compartment 240 and a cathode electrode compartment 242 which each contain an electrode 244, 246 formed from the metal based redox material, such as Cu or the like and an electrolyte comprising the amine based electrolyte discussed above. Each of the electrode compartments 240 and 242 contain an amine based electrolyte, and are separated by an anion-exchange membrane 248. The anion-exchange membrane 248 localises the electrolyte reactions to the relevant electrodes. The absorber 210 is fluidly connected to the anode compartment 240, with electrolyte flowing from the anode compartment 240 to the absorber 210 to absorb fed acid gas 220 therein. The rich solvent 228 is then fed into the cathode compartment 242 where reaction 4 occurs. The desorber/stripper 210 are fluidly connected to the cathode compartment 246, with electrolyte flowing from the cathode compartment 242 to the stripper 216 to desorb or strip the absorbed acid gas content from the rich electrolyte. Reboiler 223 is used to heat the electrolyte to a suitable stripping temperature. A condenser 225 is used to condense any electrolyte vapour near a gas exit of the stripper 216 to ensure that electrolyte is not emitted with the acid gas flow 224 exiting the stripper 216. The resulting lean electrolyte 227A from the stripper 216 is then fed into the anode compartment 240. A heat exchanger 214 is used to transfer heat from the lean electrolyte stream 227A fed from stripper 216 to the rich solvent stream 228A being flowing from the cathode compartment 242. Ideally, the amount of electrolyte flowing from each of the anode and cathode compartments 240 and 242 to the absorber 210 and stripper 216 respectively are substantially the same, preferably the same, so as to maintain the volume of electrolyte in each of these compartments 240 and 242.

The electrode compartments 240 and 242 are used as transposable Anode and Cathodes (reversible polarity) where they can be interchanged from functioning as a cathode compartment and an anode compartment. Therefore, in use, the illustrated anode compartment 240 and cathode compartment 242 are selectively interchanged, preferably periodically interchanged to function as an anode compartment and a cathode compartment of the battery. The absorber 210 therefore feeds the electrolyte in the respective anode compartment a solution of absorbed or absorbable acid gas to form an acid gas absorbed electrolyte.

For example, for the Cu-ammonia system shown in reactions 7 to 10, following initial formation of the Cu-ammine complex in the anode compartment, CO₂ is captured, forming the ammonium carbamate and releasing copper(II) ions into solution. This is a spontaneous process. The anode compartment is then transposed, to become the cathode compartment for the next ‘discharge’. Another batch of ammonia is injected into the other compartment (anode side). NH₃+CO₂ are regenerated using the stripper for ammonia consumption reasons. This interposes CO₂ capture in the NH₃-processing side of the electrolytic cell.

The amine based electrolyte is therefore only used as an anolyte (electrolyte surrounding an anode) that reacts with the copper electrode as waste heat warms the electrolyte, generating electricity. When the reaction uses up the amine component of the electrolyte or depletes the metal ions in the electrolyte near the cathode the reaction stops. The addition of the acid gas then is used to distil the amine component of the electrolyte from the used anolyte. The regenerated electrolyte is then added to the cathode chamber. The electrolytic cell/battery's polarity reverses and the anode becomes the cathode and vice versa.

It should be appreciated that the process could be operated as an integrated gas/liquid contactor and electrochemical reactor, with the acid gas absorption and both anode and cathode integrated in the same compartment or stack. In this embodiment, the amine based electrolyte could react in the anode compartment with the metal based redox material, typically the metal anode, to form the metal-ammine complex. The cathode compartment includes a gas-liquid contacting arrangement, for example a porous gas-liquid contacting membrane, which enables an acid gas to be directly absorbed into the electrolyte in the anode compartment. In this arrangement, the metal-ammine complex undergoes direct reduction in the presence of an acid gas. Metal is then deposited on the cathode, as shown in reaction (14).

2CO₂+[Cu(NH₃)₄]²⁺+2e→2NH₄⁺+2NH₂COO⁻+Cu (14)

The electrolyte can then be regenerated using a heating process, or flow to a separate regenerative process, such as a stripper 216 shown in FIG. 2 to desorb the acid gas therefrom. In this way, the acid gas is intimately involved in the electrochemistry and, may provide an energy gain and a process intensification, depending on its effect on the reduction potential for copper.

In some embodiments, the acid gas, such as high purity CO₂ could also be recycled back into the electrolyte in the anode compartment. In this way, the gas could be used to generate electricity in a similar cycle as a heat engine such as an Organic Rankine Cycle.

### EXAMPLES

### Example 1: Cu(NO₃)₂ and NH₄NO₃ Battery

A Cu-ammonia CO₂ regenerative battery was prepared according to one embodiment of the present invention.

Two cells were prepared with solutions of 0.1 M Cu(NO₃)₂ and 5 M NH₄NO₃ in 50 ml beakers. One cell was charged to 2 M NH₄OH from a 5M solution, the other cell was topped up with water to balance the concentrations. Adding the NH₄OH changes the colour from light blue to dark blue (Cu(NO₃)₂ to Cu(NH₃)₄) A salt bridge filled with 5 M NH₄NO₃ was used to complete the circuit and copper electrodes were cut from copper film supplied by Sigma Aldrich.

The potential difference between the two cells was 0.34 V. Various current and power density measurements were recorded before ‘running the battery down’. The spent anolyte (containing Cu(NH₃)₄) was taken and exposed to CO₂ for more than an hour. No colour change from the disruption of the Cu(NH₃)₄ was apparent by eye. However, the pH changed from 8.6 to 6.9 after this CO₂ exposure.

### Example 2: Alternate Cu(NO₃)₂ and NH₄NO₃ Battery

A further experiment was conducted using a larger cell constructed from two 3d printed polycarbonate half cells as shown in FIG. 3. An ion selective membrane was used as supplied by Selemion. Two equal sized electrodes were cut from 1 mm thick copper foam supplied by Gelon Lib group.

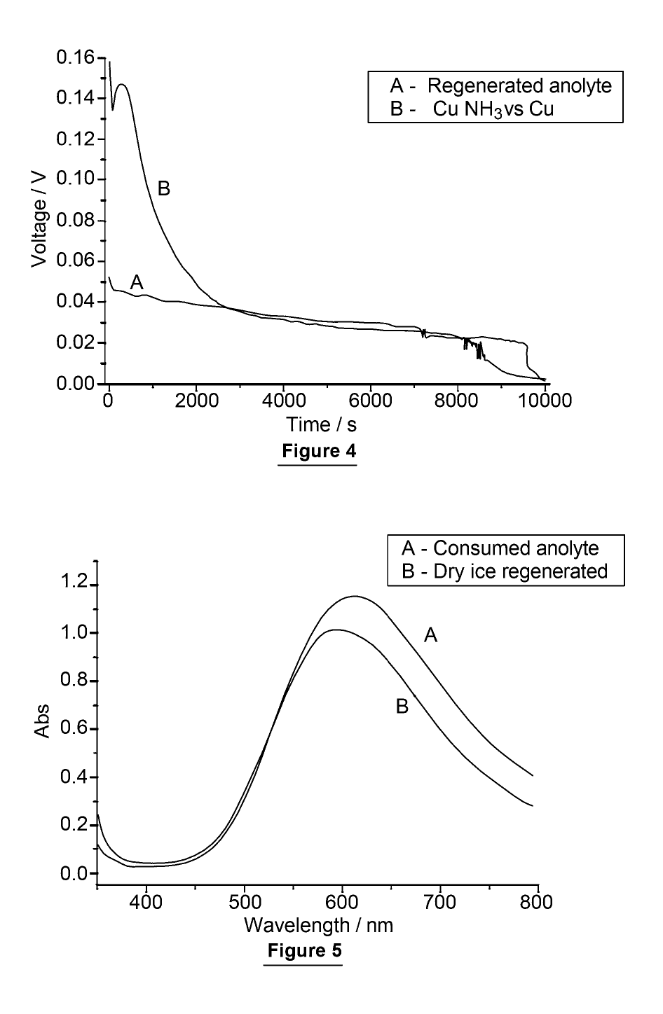

The cells were charged in the same way as described in Example 1 using 0.1 M Cu(NO₃)₂ and 5 M NH₄NO₃ and 2 M NH₄OH for the anolyte and 0.1 M Cu(NO₃)₂ and 5 M NH₄NO₃ for the catholyte, an open circuit potential of 0.5 V was recorded. Chronopotentiometry was recorded for the cell discharging against a 1.2 ohm resistor and is shown in FIG. 4. The consumed NH₃ solution was treated with solid CO₂ to regenerate the solution without evaporating NH₃. This time, the original NH₃ free solution was charged with NH₃ and run against the CO₂ regenerated solution, an open circuit potential of 0.19 V was recorded along with chronopotentiometry as shown in the figure. The potential recorded demonstrates the possibility of using a CO₂ or other acid gas to disrupt the Cu[NH₃]ₓ complex and thereby recharge the battery.

The absorption spectra of the spent and regenerated solution were are shown in the FIG. 5. A˜15 nm blue shift in the absorption peak of the CO₂ sample was observed. This is consistent with a change in the solution from the dominant species in solution being Cu(NH₃)₅ to the dominant species being Cu(NH₃)₄, as seen in literature data (for example Bjerrum, j., Nielsen, E. J., Acta Chemica Scandinavica, 2 (1948) 297-318). This also fits with modelling data using the stability constants that show as the pH is decreased from >11 to pH<8 Cu(NH₃)₅ is replaced as the dominant species by Cu(NH₃)₄ (International Journal of Greenhouse Gas Control, (2014), 54-63).

### Example 3: Applicable Metals

Several metals could potentially be used for the process. For aqueous ammonia solutions data on metal-amine equilibria is commonly available. Table 1 provides examples of the metals that could be used in combination with ammonia as the complexing agent and the open circuit potential determined from the equilibrium constants. The acid gas carbon dioxide (CO₂) will react with ammonia via the carbamate formation step:

CO₂+2NH₃->NH₄⁺+NH₂COO⁻ (15)

and bicarbonate formation step:

CO₂+NH₃+H₂O->NH₄⁺+HCO₃⁻ (16)

The maximum of energy (or work) that could be produced by the reactions of the ammonia complexes with carbon dioxide can be determined by the Gibbs free energy difference for the redox reactions as determined by:

ΔG=Wₘₐₓ=−zFE

where z is the charge transferred, F equals the Faraday constant (96485 C/mol) and E is the open circuit voltage.

TABLE 1
Open circuit voltage for a range of metals with ammonia [1]

| | | | Maximum |
|---|---|---|---|
| Cathode | Anode | | work * |
| reaction and | reaction and | Open circuit | [KJ/mol |
| potential | potential | potential, V | CO₂] |
| Co²⁺ + | [Co(NH₃)₄]²⁺ + | +0.145 | 14.00 |
| 2e → Co(s) | 2e → Co(s) + 4NH₃ | | |
| E = −0.277 V | E = −0.422 V | | |
| Cd²⁺ + | [Cd(NH₃)₄]²⁺ + | +0.219 | 21.12 |
| 2e → Cd(s) | 2e → Cd(s) + 4NH₃ | | |
| E = −0.403 V | E = −0.622 V | | |
| Ni²⁺ + | [Ni(NH₃)₆]²⁺ + | +0.233 | 14.98 |
| 2e → Ni(s) | 2e → Ni(s) + 6NH₃ | | |
| E = −0.257 V | E = −0.49 V | | |
| Zn²⁺ + | [Zn(NH₃)₄]²⁺ + | +0.277 | 26.72 |
| 2e → Zn(s) | 2e →Zn(s) + 4NH₃ | | |
| E = −0.763 V | E = −1.04 V | | |
| Cu²⁺ + | [Cu(NH₃)₄]²⁺ + | +0.380 | 36.67 |
| 2e → Cu(s) | 2e →Cu(s) + 4NH₃ | | |
| E = +0.34 V | E = −0.04 V | | |
| Ag⁺ + | [Ag(NH₃)₂]⁺ + | +0.430 | 41.48 |
| e → Ag(s) | e → Ag(s) + 2NH₃ | | |
| E = +0.80 V | E = +0.37 | | |
| Hg²⁺ + | [Hg(NH₃)₄]²⁺ + | +0.570 | 55.00 |
| 2e → Hg(l) | 2e → Hg(l) + 4NH₃ | | |
| E = +0.8535 V | E = +0.283 V | | |
| Pd²⁺ + | [Pd(NH₃)₄]²⁺ + | +0.915 | 88.28 |
| 2e → Pd(s) | 2e → Pd(s) + 4NH₃ | | |
| E = +0.915 V | E = 0.0 V | | |
| Pt²⁺ + | [Pt(NH₃)₆]²⁺ + | +1.044 | 67.16 |
| 2e → Pt(s) | 2e → Pt(s) + 6NH₃ | | |
| E = +1.188 V | E = +0.144 V | | |

Note:
* maximum work calculation based on the CO₂ reacting with ammonia via carbamate formation to completely release free metal ions from the complex.
[1] Speight, J. G., 2005. Lange's Handbook of Chemistry, 16th edition. McGraw-Hill Companies, Inc, Laramie, Wyoming, Table 1.358 and 1.380

### Example 4: Applicable Amines

A wide range of amines can be applied in the process in the amine base electrolyte, including alkanolamines, alkylamines and amino-acid salts solutions.

An electrochemical cell was designed and manufactured using a 3-D printer. It was subsequently operated to evaluate the battery energy performance using different metals and amines by connecting the Potentiostat Electrochemical Systems (Autolab PGSTAT12, Metrohm). The cell consists of anode and cathode compartments separated by an anion exchange membrane (AEM, Selemion AMV, Japan) with surface area 6.96 cm². The distance of two electrodes is 1.0 cm to decrease the solution resistance. Ag/AgCI reference electrodes (199 my versus Standard Hydrogen Electrode, Pine research) was used to monitor the potential changes for anode and cathode electrode. Table 2 and Table 3 provide the experimental results of power generation performance using different amine base electrolytes and metals at room temperature (20-22° C.). The catholyte is CO₂-loaded which is representative of the solution after CO₂ absorption, while the anolyte is non CO₂-loaded representative of the solution after CO₂ desorption. Each catholyte and anolyte contains 2M amines, 0.1 M Cu(II) and 1 M NH₄NO₃ or 1 M KNO₃ as supporting electrolyte.

### Example 5

Using the procedure described in Example 4, experiments were carried for Zn as the metal active in the electrochemical cell. Each catholyte and anolyte contains 2M amines, 0.1 M Zn(II) and 1 M NH₄NO₃ or 1 M KNO₃ as supporting electrolyte.

Table 3 provides the experimental results of power generation performance using different amines at room temperature (20-22° C.).

TABLE 2
Results summary of energy performance using different amines and Cu/Cu²⁺ as the redox couple

| | | | | | | |
|---|---|---|---|---|---|---|
| | | | | | | Measured |
| | | | | | Open | maximum |
| | | | | | circuit | power |
| | | | | CO₂ loading | potential, | density, |
| No. | Solvent | Structure | pKa | in cathode | v | W/m^{2*} |

Amino acid salts (neutralised by KOH)

| | | | | | | |
|---|---|---|---|---|---|---|
| 1 | L-Arginine | 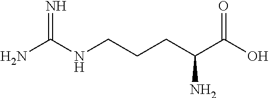 [SMILES: N=C(N)NCCC[C@H](N)C(=O)O] | 8.99 | 1.28 | 0.09 | 0.15 |
| 2 | Taurine | 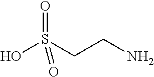 | 9.06 | 0.42 (solid) | 0.24 | 2.52 |
| 3 | L-Threonine | 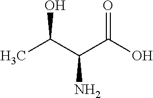 | 9.1 | 0.45 | 0.096 | 0.79 |
| 4 | L-Serine | 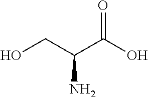 | 9.15 | 0.48 | 0.092 | 0.49 |
| 5 | Glutamic acid | 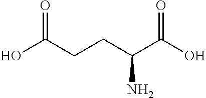 | 9.47 | 0.28 | 0.11 | 0.27 |
| 6 | Glycine | 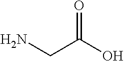 | 9.6 | 0.50 | 0.144 | 1.21 |
| 7 | L-Alanine | 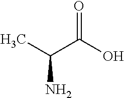 | 9.69 | 0.51 | 0.20 | 1.48 |
| 8 | Sarcosine | 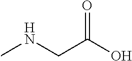 | 10.05 | 0.48 | 0.145 | 0.52 |
| 9 | L-Proline | 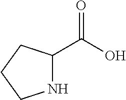 | 10.6 | 0.59 | 0.182 | 0.91 |

Alkylamines

| | | | | | | |
|---|---|---|---|---|---|---|
| 1 | Ammonia | NH₃ | 9.24 | 0.5 | 0.09 | 0.96 |
| 2 | Propylamine | 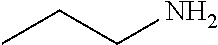 | 10.93 | 0.61 | 0.22 | 3.52 |
| 3 | Butylamine | 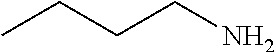 | 10.65 | 0.5 | 0.19 | 2.37 |
| 4 | Amylamine | 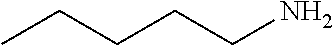 | 10.81 | 0.5 (volatile) | 0.27 | 4.83 |
| 5 | Ethylenediamine | 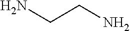 | 9.93 | 0.96 | 0.24 | 2.93 |
| 6 | 1,3 Diaminopropane | 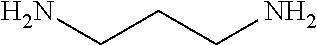 | 10.4 | 1.0 | 0.25 | 3.23 |
| 7 | hexamethylenediamine | 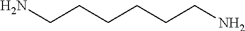 | 10.9 | 1.1 | 0.24 | 2.88 |
| 8 | m-Xylylenediamine | 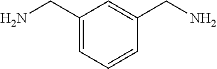 | 9.2 | 0.81 (precipitation) | 0.28 | 4.20 |
| 9 | 1-(3-aminopropyl)- imidazole | 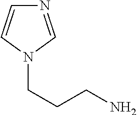 | 9.6 | 0.75 | 0.12 | 0.81 |
| 10 | Piperazine | 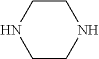 | 9.73 | 0.84 | 0.21 | 2.88 |
| 11 | 4-methylpiperidine | 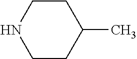 | 11.27 | 0.56 | 0.13 | 0.91 |
| 12 | Pyrrolidine | 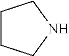 | 11.35 | 0.61 | 0.2 | 1.05 |
| 13 | 3-(dimethylamino)-1- propylamine | 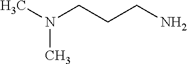 | — | 1.03 | 0.21 | 2.6 |
| 14 | N-Methyl-1,3- diaminopropane | 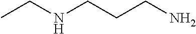 | — | 1.03 | 0.20 | 1.39 |

Alkanolamines

| | | | | | | |
|---|---|---|---|---|---|---|
| 1 | Triethanolamine | 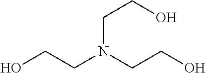 | 7.76 | 0.56 | 0.09 | 0.38 |
| 2 | 2-amino-2-methyl-1 3- propanediol | 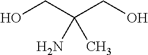 | 8.8 | 0.63 | 0.14 | 1.25 |
| 3 | Diethanolamine | 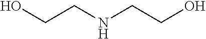 | 8.88 | 0.55 | 0.14 | 1.56 |
| 4 | bis(2-hydroxypropyl)- amine | 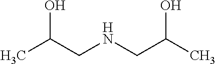 | 9.1 | 0.47 | 0.12 | 0.76 |
| 5 | 2-(2-Aminoethoxy)- ethanol | 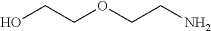 | 9.3 | 0.52 | 0.22 | 3.34 |
| 6 | Ethanolamine | 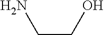 | 9.5 | 0.49 | 0.214 | 2.17 |
| 7 | 3-Amino-1-propanol | 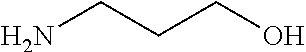 | 10 | 0.64 | 0.268 | 2.73 |
| 8 | 5-Amino-1-pentanol | 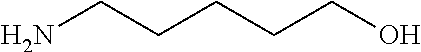 | 10.5 | 0.56 | 0.218 | 2.82 |

Note: * the power density is calculated based on the effective membrane area.

TABLE 3
Results summary of energy performance using different amines and Zn/Zn²⁺ as the redox couple

| | | | | | | Measured |
|---|---|---|---|---|---|---|
| | | | | CO₂ | Open | maximum |
| | | | | loading | circuit | power |
| | | | | in | potential, | density, |
| No. | Solvent | Structure | pKa | cathode | V | W/m^{2*} |
| 1 | Ammonia | NH₃ | 9.24 | 0.5 | 0.11 | 2.57 |
| 2 | Propylamine | 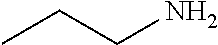 | 10.93 | 0.53 | 0.133 | 0.53 |
| 3 | 3-Amino-1-propanol | 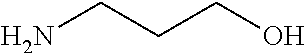 | 10 | 0.55 | 0.24 | 0.52 |
| 4 | 5-Amino-1-pentanol | 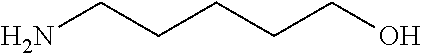 | 10.5 | 0.51 | 0.09 | 2.50 |
| 5 | Piperazine | 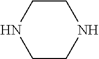 | 9.73 | 0.815 | 0.15 | 0.79 |
| 6 | Ethylenediamine | 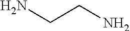 | 9.93 | 0.96 | 0.15 | 1.64 |
| 7 | 1,3 Diaminopropane | 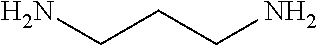 | 10.4 | 1.0 | 0.21 | 3.5 |
| 8 | hexamethylenediamine | 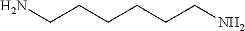 | 10.9 | 1.09 | 0.142 | 1.06 |

Note: * the power density is calculated based on the effective membrane area

### Example 6

Using the procedure described in example 4, an experiment was conducted for Co²⁺/Co³⁺ representing a valence changeable metal for the redox couple in the electrochemical cell. The use of multi-valence metals enables the full flow battery without alternating the metal electrode used in Examples 4 and 5, as the electrodes are not affected by metal dissolution or deposition. Graphite was used as the electrode material for the electron transfer. Each catholyte and anolyte contained 1 M NH₄NO₃ as supporting electrolyte. Table 4 provides the experimental open circuit potential at room temperature (20-22° C.).

TABLE 4
Experimental results of open circuit potential
using Co²⁺/Co³⁺ as redox couple

| | | Anolyte | Catholyte | Open circuit |
|---|---|---|---|---|
| No. | Solvent | composition | composition | potential, V |
| 1 | Ammonia | 2M NH₃ | 2M NH₃; | ±0.01 ^{a} |
| | (NH₃) | | 0.5 CO₂ loading | |
| 2 | Ammonia | 2M NH₃, | 2M NH₃; | 0.16 ^{b} |
| | (NH₃) | 0.2M Co²⁺/ | 0.5 CO₂ loading; | |
| | | 0.2M Co³⁺ | 0.2M Co²⁺/0.2M | |
| | | | Co³⁺ | |
| 3 | Ethanolamine | 4M MEA; | 4M MEA; | 0.25 |
| | (MEA) | 0.1M Co²⁺/ | 0.35 CO₂ loading; | |
| | | 0.1M Co³⁺ | 0.1M Co²⁺/0.1M | |
| | | | Co³⁺ | |

Note:
^{a} The open circuit potential of the test without the redox couple;
^{b} Fine particle were observed in the cathode compartment.

A non-exhaustive list of applications for the process and the electrolytic cell of the present invention are as follows:
Acid gas treatment: Power can be generated from the separation of acid gas in conventional gas treatment. The present invention could for example supply part of the electrical energy requirement of an LNG train or a compression process.
Biogas treatment: The production of methane from biogas using an amine based process could provide electricity as well. The need to remove CO₂ to produce sales gas quality could be used beneficially to generate power, in addition to the high quality methane product.
CO₂-capture from air: CO₂ capture from air could be used to generate power directly with regeneration of the liquid absorbents being carried e.g. by solar thermal energy. In some forms, a small scale system could be utilised to generate electricity through CO₂ capture from air (for example during night time) when power is needed for lighting etc. with regeneration of the liquid absorbents occurring during the day. In particular, amino-acid salt solution could be used for this purpose as they have no vapour pressure and hence no losses to the atmosphere.
CO₂-capture from flue gas (Post Combustion Capture—PCC): A PCC process with the present invention could have an energy consumption close to its thermodynamic minimum.
Regenerative desulphurisation: Apart from CO₂, other gases like SO₂ can be utilised in the process of the present invention as described above. In one example, the present invention could be used as part of the CANSOLV process—an amine based desulphurisation process.
Coal seam gas conditioning: Coal seam gas has relatively low CO₂ content (<1%) which is removed in a central unit before the liquefaction. The present invention could be used to generate power from decentralised CO₂-separation processes with the power used for gas compression processes.
Miscellaneous CO₂-removal applications: Other CO₂-removal applications may include use in submarines, space-crafts and greenhouses where amine based scrubbing processes are used, and can include the present invention. Again, in some forms the capture of CO₂ from a combustion facility (or maybe from air) at night could provide electricity for use in lighting or other power applications. The CO₂-stored in the liquid absorbent can be released during the day using solar thermal energy. This can be particularly relevant to greenhouse applications, where CO₂ is injected into the greenhouse during daytime to promote plant growth and crop production. At night light is required to sustain the photo-synthesis processes in the plants. Using the process of this invention the electricity required could be generated through the absorption of CO₂.
Operation with pure CO₂ (or other acid gas), where CO₂ released from the liquid absorbent regeneration would be fed back to the metal-ammine solution and re-absorbed. The system will work as a heat engine with the heat of regeneration converted into electricity.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

### REFERENCES

1. Enhancing Low-Grade Thermal Energy Recovery in a Thermally Regenerative Ammonia Battery Using Elevated Temperatures, Fang Zhang, Nicole LaBarge, Wulin Yang, Jia Liu and Bruce E. Logan, ChemSusChem 2015, 8, 1043-1048.
2. A thermally regenerative ammonia-based battery for efficient harvesting of low-grade thermal energy as electrical power, Fang Zhang, Nicole LaBarge, Wulin Yang, Jia Liu and Bruce E. Logan Energy Environ. Sci., 2015, 8, 343-349.
3. Theoretical and experimental study of NH₃ suppression by addition of Me (II) ions (Ni, Cu and Zn) in an ammonia based CO₂ capture process, Kangkang Li, Hai Y, Moses Tade, Paul Feron, International Journal of Greenhouse Gas Control 24 (2014) 54-63.

1. A method of generating electricity from an amine-based acid gas capture process using an electrolytic cell containing an anode and a cathode and an amine based electrolyte comprising:
contacting a metal based redox material with an amine based electrolyte in the presence of an anode to form a metal-ammine complex in solution;
adding an absorbed or absorbable acid gas to the metal-ammine complex containing electrolyte to form an acid gas absorbed electrolyte; and
contacting the acid gas absorbed electrolyte with a cathode deposit,
wherein the acid gas breaks up the metal-ammine complex in the metal-ammine complex containing electrolyte thereby generating a potential difference between the anode and the cathode.

2. A method according to claim 1, wherein the acid gas comprises at least one of CO₂, NO₂, SO₂, H₂S, HCl, HF, or HCN or a combination thereof.

3. A method according to claim 1, wherein the acid gas comprises a flue gas.

4. A method according to claim 1, wherein the acid gas includes CO₂ as a major component.

5. A method according to claim 1, wherein the metal based redox material comprises at least one of Cu, Ni, Zn, Co, Pt, Ag, Cr, Pb, Cd, Hg, Pd or a combination thereof.

6. A method according to claim 1, wherein the metal comprises Cu, Ni or Zn, preferably Cu.

7. A method according to claim 1, wherein the anode and cathode comprise the metal based redox material.

8. (canceled)

9. A method according to claim 1, wherein the metal based redox material comprises a multivalent metal ion which is in a first valence state when in solution and a second valence state when in the metal-ammine complex.

10. A method according to claim 1, wherein the amine based electrolyte comprises the general formula R₁R₂R₃N, wherein R₁, R₂ and R₃ comprise hydrogen, unsubstituted or substituted C1-C20 alkyl, or unsubstituted or substituted aryl.

11. A method according to claim 1, wherein the amine based electrolyte comprises at least one of ammonia, alkylamines, alkanolamines, amino-acid salts or combination thereof.

12. A method according to claim 1, wherein the amine based electrolyte comprises at least one of:
an amino acid salt selected from the group consisting of L-Arginine, Taurine, L-Threonine, L-Serine, Glutamic acid, Glycine, L-Alanine, Sarcosine, and L-Proline;
an alkylamine selected from the group consisting of Ammonia, Propylamine, Butylamine, Amylamine, Ethylenediamine, 1,3 Diaminopropane, hexamethylenediamine, m-Xylylenediamine, 1-(3-aminopropyl)imidazole, Piperazine, 4-methylpiperidine, Pyrrolidine, 3-(dimethylamino)-1-propylamine, and N-Methyl-1,3-diaminopropane;
an alkanolamine selected from the group consisting of Triethanolamine, 2-amino-2-methyl-1,3-propanediol, Diethanolamine, bis(2-hydroxypropyl)amine, 2-(2-Aminoethoxy)ethanol, Ethanolamine, 3-Amino-1-propanol and 5-Amino-1-pentanol; or
an aqueous ammonia solution.

13. (canceled)

14. A method according to claim 1, wherein the metal based redox materials comprises Cu and the amine based electrolyte comprises ammonia and the metal-ammine complex comprises [Cu(NH₃)_{4]}²⁺.

15. (canceled)

16. A method according to claim 1, wherein a gas-liquid contactor is used to form the solution of acid gas to the metal-ammine complex containing electrolyte.

17. A method according to claim 1, wherein the method further includes the step of:
after contacting the acid gas absorbed electrolyte with a cathode, heating the acid gas absorbed electrolyte to release the absorbed acid gas therefrom and thermally regenerate the amine based electrolyte.

18. (canceled)

19. A method according to claim 1, wherein the electrolytic cell includes an anode chamber and a cathode chamber, and the metal based redox material is contacted with an amine based electrolyte in the anode chamber, and wherein, in use, the electrolytic cell comprises a first electrode compartment and second electrode compartment that are cyclically interchanged as the anode chamber and the cathode chamber of the electrolytic cell.

20. (canceled)

21. (canceled)

22. (canceled)

23. An acid gas regenerable electrolytic cell comprising:
a first electrode compartment containing an electrode comprising at least one metal based redox material and a first electrolyte comprising an amine based electrolyte;
a second electrode compartment containing an electrode comprising at least one metal based redox material and a second electrolyte comprising an amine based electrolyte; and
a gas-liquid contactor located to operatively contact at least one of the first electrolyte or second electrolyte to facilitate acid gas absorption within the electrolyte,
wherein, in use, the first electrode compartment and second electrode compartment are cyclically interchanged as an anode compartment and an cathode compartment of the electrolytic cell.

24. An acid gas regenerable electrolytic cell according to claim 23, wherein the first electrode compartment and second electrode compartments are fluidly separated by an anion exchange membrane.

25. (canceled)

26. An acid gas regenerable electrolytic cell according to claim 23, wherein at least the first or second electrolyte comprises an amine based electrolyte having the general formula R₁R₂R₃N, wherein R₁, R₂ and R₂ comprise hydrogen, unsubstituted or substituted C1-C20 alkyl, or unsubstituted or substituted aryl.

27. An acid gas regenerable electrolytic cell according to claim 23, wherein the metal based redox material comprises at least one of Cu, Ni, Zn, Co, Pt, Ag, Cr, Pb, Cd, Hg, Pd or a combination thereof.

28. (canceled)

29. (canceled)

30. An acid gas regenerable electrolytic cell according to claim 23, wherein the first electrode compartment and second electrode compartment are cyclically interchanged as an anode compartment and an cathode compartment of the electrolytic cell when at least one of:
a specified amount of metal based redox material is removed from the electrode;
the potential difference/voltage between the anode and cathode falls below a specified level/voltage;
a specified amount of amine based electrolyte is reacted; or
the metal based redox material has contacted the amine based electrolyte is reacted for a specified amount of time.

31. (canceled)

32. (canceled)

33. (canceled)

34. (canceled)

35. (canceled)

36. (canceled)

37. (canceled)

38. (canceled)
